(19) United States
(12) Patent Application Publication
(10) Pub. No.: US 2019/0273268 A1
(43) Pub. Date: Sep. 5, 2019

(54) FRAME EQUIPPED MEMBRANE ELECTRODE ASSEMBLY, METHOD OF PRODUCING THE FRAME EQUIPPED MEMBRANE ELECTRODE ASSEMBLY, AND FUEL CELL

(71) Applicant: HONDA MOTOR CO., LTD., TOKYO (JP)

(72) Inventors: Yutaka EBATO, WAKO-SHI (JP); Hiroyuki TANAKA, PONTIAC, MI (US)

(21) Appl. No.: 15/910,752

(22) Filed: Mar. 2, 2018

(51) Int. Cl. H01M 8/0273; H01M 8/1004; H01M 8/1018; H01M 8/242

(52) U.S. Cl. CPC H01M 8/0273; H01M 8/1004; H01M 2250/20; H01M 8/242; H01M 2008/1095; H01M 8/1018

(57) ABSTRACT

A frame equipped membrane electrode assembly includes a membrane electrode assembly and a frame member. The frame member includes a first frame shaped sheet and a second frame shaped sheet. An inner peripheral portion of the first frame shaped sheet is joined to an outer peripheral portion of the membrane electrode assembly. The inner peripheral portion of the first frame shaped sheet is disposed between an outer peripheral portion of an anode and an outer peripheral portion of a cathode. A gap is formed between an inner end of the second frame shaped sheet and an outer end of the cathode. The first frame shaped sheet and the second frame shaped sheet are joined together over the entire periphery by an adhesive layer.

### BACKGROUND OF THE INVENTION

### Field of the Invention

The present invention relates to a frame equipped membrane electrode assembly, a method of producing the frame equipped membrane electrode assembly, and a fuel cell.

### Description of the Related Art

In general, a solid polymer electrolyte fuel cell employs a solid polymer electrolyte membrane. The solid polymer electrolyte membrane is a polymer ion exchange membrane. In the fuel cell, an anode is provided on one surface of the solid polymer electrolyte membrane, and a cathode is provided on the other surface of the solid polymer electrolyte membrane, respectively to form a membrane electrode assembly (MEA).

The membrane electrode assembly is sandwiched between separators (bipolar plates) to form a power generation cell (unit fuel cell). In use, a predetermined number of power generation cells are stacked together to form a fuel cell stack. For example, the fuel cell stack is mounted in a vehicle as an in-vehicle fuel cell stack.

In recent years, in an attempt to reduce the quantity of the relatively expensive solid polymer electrolyte membrane, and protect the thin solid polymer electrolyte membrane having low strength, a frame equipped MEA including a resin frame member in its outer periphery has been adopted.

### SUMMARY OF THE INVENTION

In U.S. Pat. No. 8,399,150, a shim or a spacer is provided not over the entire periphery, but in part of one surface of a single layer resin frame member. In this structure, when holes and/or cracks are formed in the resin frame member, it becomes impossible to achieve desired gas shielding performance and/or electrical insulating performance. Further, the resin frame member tends to be deformed easily in the presence of the pressure difference between the anode and the cathode.

In Japanese Laid-Open Patent Publication No. 2013-515348 (PCT), a resin frame member is formed by two layers of sheets. Since an electrolyte membrane is interposed between the sheets, the production cost is high disadvantageously.

The present invention has been made taking the problems into consideration, and object of the present invention is to provide a frame equipped membrane electrode assembly, a method of producing the frame equipped membrane electrode assembly, and a fuel cell in which it is possible to improve the reliability of preventing formation of holes and/or cracks in a frame member, achieve structure where deformation does not occur easily in the presence of the pressure difference between an anode and a cathode, and achieve reduction in the production cost.

In order to achieve the above object, the present invention provides a frame equipped membrane electrode assembly including a membrane electrode assembly and a frame member. The membrane electrode assembly includes an electrolyte membrane, a first electrode provided on one surface of the electrolyte membrane, and a second electrode provided on another surface of the electrolyte membrane. A surface size of the second electrode is smaller than a surface size of the first electrode. The frame member is provided over an entire periphery of an outer peripheral portion of the membrane electrode assembly. The frame member includes a first frame shaped sheet and a second frame shaped sheet. An inner peripheral portion of the first frame shaped sheet is joined to the outer peripheral portion of the membrane electrode assembly. The first frame shaped sheet and the second frame shaped sheet are joined together in a thickness direction. The inner peripheral portion of the first frame shaped sheet is disposed between an outer peripheral portion of the first electrode and an outer peripheral portion of the second electrode. A gap is formed between an inner end of the second frame shaped sheet and an outer end of the second electrode, and the first frame shaped sheet and the second frame shaped sheet are joined together directly over an entire periphery by an adhesive layer.

Preferably, the inner peripheral portion of the first frame shaped sheet includes an overlap part overlapped with the outer peripheral portion of the first electrode as viewed in a thickness direction of the membrane electrode assembly.

Preferably, the adhesive layer is provided over the entire surface of the first frame shaped sheet adjacent to the second frame shaped sheet, and the inner peripheral portion of the first frame shaped sheet and an outer peripheral portion of the electrolyte membrane are joined together by the adhesive layer.

Preferably, an inner peripheral portion of the second frame shaped sheet includes an overlap part overlapped with the outer peripheral portion of the first electrode as viewed in a thickness direction of the membrane electrode assembly.

Preferably, the entire surface of the second frame shaped sheet adjacent to the first frame shaped sheet is joined to the first frame shaped sheet directly over the entire periphery by the adhesive layer.

Further, the present invention provides a fuel cell including a frame equipped membrane electrode assembly and separators stacked on both sides of the frame equipped membrane electrode assembly, respectively. The frame equipped membrane electrode assembly includes a membrane electrode assembly and a frame member. The membrane electrode assembly includes an electrolyte membrane, a first electrode provided on one surface of the electrolyte membrane, and a second electrode provided on another surface of the electrolyte membrane. A surface size of the second electrode is smaller than a surface size of the first electrode. The frame member is provided over the entire periphery of an outer peripheral portion of the membrane electrode assembly. The frame member includes a first frame shaped sheet and a second frame shaped sheet. An inner peripheral portion of the first frame shaped sheet is joined to the outer peripheral portion of the membrane electrode assembly. The first frame shaped sheet and the second frame shaped sheet are joined together in a thickness direction. The inner peripheral portion of the first frame shaped sheet is disposed between an outer peripheral portion of the first electrode and an outer peripheral portion of the second electrode. A gap is formed between an inner end of the second frame shaped sheet and an outer end of the second electrode, and the first frame shaped sheet and the second frame shaped sheet are joined together directly over the entire periphery by an adhesive layer.

Preferably, the overlap part where the first electrode, the first frame shaped sheet, and the second electrode are overlapped together is held between a ridge provided in one of the separators and protruding toward the first electrode and a ridge provided in another of the separators and protruding toward the second electrode.

Preferably, a bead seal is formed integrally with each of the separators to protrude toward the frame member, and configured to prevent leakage of a reactant gas, and an overlap area of the frame member where the first frame shaped sheet and the second frame shaped sheet are overlapped together is held between the bead seal of one of the separators and the bead seal of the other of the separators from both sides in a thickness direction.

Preferably, a solid seal made of an elastic member is provided for each of the separators, and configured to prevent leakage of a reactant gas, and an overlap area of the frame member where the first frame shaped sheet and the second frame shaped sheet are overlapped together is held between the solid seal of one of the separators and the solid seal of another of the separators from both sides in a thickness direction.

Preferably, the first electrode is an anode and the second electrode is a cathode.

Preferably, the first electrode is a cathode, and the second electrode is an anode.

Further, the present invention provides a method of producing a frame equipped membrane electrode assembly. The frame equipped membrane electrode assembly includes a membrane electrode assembly and a frame member. The membrane electrode assembly includes an electrolyte membrane, a first electrode provided on one surface of the electrolyte membrane, and a second electrode provided on another surface of the electrolyte membrane. A surface size of the second electrode is smaller than a surface size of the first electrode. The frame member is provided over the entire periphery of an outer peripheral portion of the membrane electrode assembly. The frame member includes a first frame shaped sheet and a second frame shaped sheet, an inner peripheral portion of the first frame shaped sheet is joined to the outer peripheral portion of the membrane electrode assembly. The first frame shaped sheet and the second frame shaped sheet are joined together in a thickness direction. The method includes the steps of providing a first sheet by providing an adhesive sheet having adhesive coated on one entire surface of the first sheet as the first frame shaped sheet before being formed into a frame shape, providing a second sheet by providing the second frame shaped sheet as the second sheet, and laminating the adhesive sheet and the second frame shaped sheet by joining the adhesive sheet and the second frame shaped sheet over the entire periphery of the second frame shaped sheet through the adhesive.

Preferably, the method of producing the frame equipped membrane electrode assembly further includes the steps of trimming the first sheet in a frame shape by forming an opening in the adhesive sheet at a position inside an inner end of the second frame shaped sheet, and joining components of an MEA in a state where a gap is formed between an inner end of the second frame shaped sheet and an outer end of the second electrode, by disposing the inner peripheral portion of the first sheet between the outer peripheral portion of the first electrode and the outer peripheral portion of the second electrode and joining the membrane electrode assembly and the frame member together.

Preferably, a thickness of the first frame shaped sheet and a thickness of the second frame shaped sheet are same.

Preferably, a thickness of the second frame shaped sheet is larger than a thickness of the first frame shaped sheet.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing main components of a power generation cell according to an embodiment of the present invention;

FIG. 2 is a cross sectional view taken along a line II-II in FIG. 1;

FIG. 3 is a view showing a first sheet providing step, a second sheet providing step, and a laminating step of a frame equipped membrane electrode assembly;

FIG. 4A is a view showing a trimming step;

FIG. 4B is a view showing an MEA joining step; and

FIG. 4C is a perspective view showing an obtained frame equipped membrane electrode assembly.

### DESCRIPTION OF THE PREFERRED EMBODIMENTS

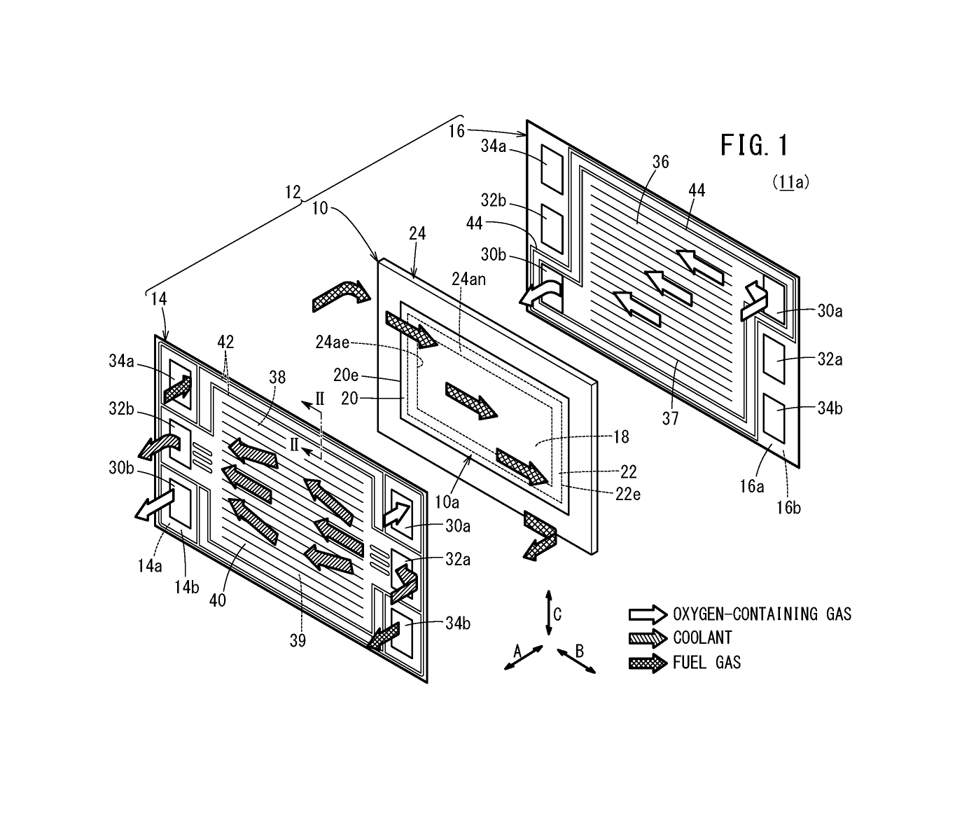

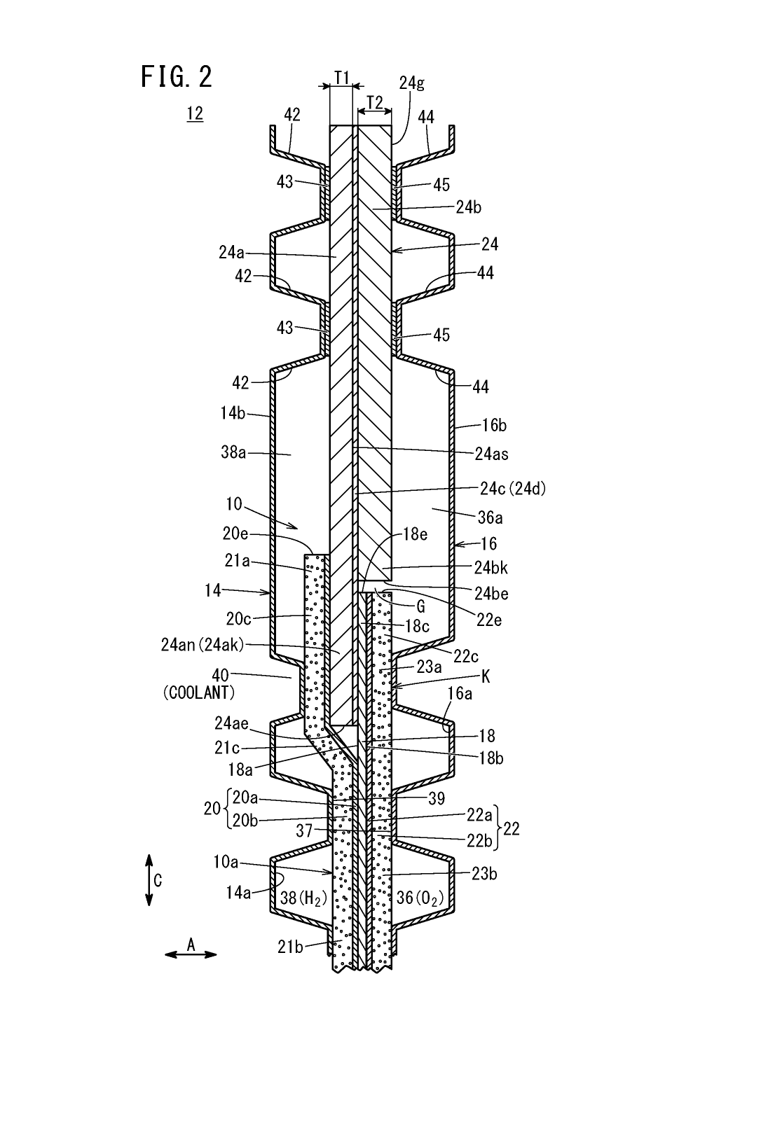

As shown in FIGS. 1 and 2, a power generation cell (fuel cell) 12 includes a frame equipped membrane electrode assembly 10 (hereinafter referred to as the “frame equipped MEA 10”), and a first separator 14 and a second separator 16 provided on both sides of the frame equipped MEA 10, respectively. For example, the power generation cell 12 is a laterally elongated (or longitudinally elongated) rectangular solid polymer electrolyte fuel cell. A plurality of the power generation cells 12 are stacked together in a horizontal direction indicated by an arrow A or in a gravity direction indicated by an arrow C to form a fuel cell stack 11a. For example, the fuel cell stack 11a is mounted as an in-vehicle fuel cell stack, in a fuel cell electric automobile (not shown).

In the power generation cell 12, the frame equipped MEA 10 is sandwiched between the first separator 14 and the second separator 16. Each of the first separator 14 and the second separator 16 has a laterally elongated (or longitudinally elongated) rectangular shape. For example, each of the first separator 14 and the second separator 16 is a steel plate, a stainless steel plate, an aluminum plate, a plate steel plate, a metal plate having an anti-corrosive surface by surface treatment, a carbon member, or the like.

The rectangular frame equipped MEA 10 includes a membrane electrode assembly 10a (hereinafter referred to as the “MEA 10a”). The MEA 10a includes an electrolyte membrane 18, an anode (first electrode) 20 provided on one surface of the electrolyte membrane 18, and a cathode (second electrode) 22 provided on another surface of the electrolyte membrane 18.

For example, the electrolyte membrane 18 is a solid polymer electrolyte membrane (cation ion exchange membrane). The solid polymer electrolyte membrane is formed by impregnating a thin membrane of perfluorosulfonic acid with water, for example. The electrolyte membrane 18 is interposed between the anode 20 and the cathode 22. A fluorine based electrolyte may be used as the electrolyte membrane 18. Alternatively, an HC (hydrocarbon) based electrolyte may be used as the electrolyte membrane 18.

The surface size (outer size) of the anode 20 is larger than the surface sizes of the electrolyte membrane 18 and the cathode 22. Therefore, the outer end of the anode 20 is positioned outside an outer end 18e of the electrolyte membrane 18 and an outer end 22e of the cathode 22, over the entire periphery. Instead of adopting the above structure, the surface size of the anode 20 may be smaller than the surface sizes of the electrolyte membrane 18 and the cathode 22.

As shown in FIG. 2, the anode 20 includes a first electrode catalyst layer 20a joined to one surface 18a of the electrolyte membrane 18 and a first gas diffusion layer 20b stacked on the first electrode catalyst layer 20a. The surface size of the first electrode catalyst layer 20a and the surface size of the first gas diffusion layer 20b are the same, and larger than the surface sizes of the electrolyte membrane 18 and the cathode 22.

The surface size of the cathode 22 is smaller than the surface size of the anode 20. The outer end 22e of the cathode 22 and the outer end 18e of the electrolyte membrane 18 are positioned inside an outer end 20e of the anode 20 over the entire periphery.

It should be noted that the surface size of the cathode 22 may be larger than the surface size of the anode 20, and the outer end 22e of the cathode 22 may be provided outside the outer end 20e of the anode 20 over the entire periphery.

The cathode 22 includes a second electrode catalyst layer 22a joined to a surface 18b of the electrolyte membrane 18 and a second gas diffusion layer 22b stacked on the second electrode catalyst layer 22a. The surface size of the second electrode catalyst layer 22a, the surface size of the second gas diffusion layer 22b, and the surface size of the electrolyte membrane 18 are the same. Therefore, as viewed in the thickness direction (indicated by the arrow A) of the MEA 10a, the outer end 22e of the cathode 22 and the outer end 18e of the electrolyte membrane 18 are at the same position over the entire periphery.

For example, the first electrode catalyst layer 20a is formed by porous carbon particles deposited uniformly on the surface of the first gas diffusion layer 20b together with an ion conductive polymer binder, and platinum alloy supported on the porous carbon particles. For example, the second electrode catalyst layer 22a is formed by porous carbon particles deposited uniformly on the surface of the second gas diffusion layer 22b together with an ion conductive polymer binder, and platinum alloy supported on the porous carbon particles.

Each of the first gas diffusion layer 20b and the second gas diffusion layer 22b comprises a carbon paper or a carbon cloth, etc. The surface size of the second gas diffusion layer 22b is smaller than the surface size of the first gas diffusion layer 20b. The first electrode catalyst layer 20a and the second electrode catalyst layer 22a are formed on both surfaces of the electrolyte membrane 18, respectively.

The frame equipped MEA 10 is formed around the entire outer periphery of the electrolyte membrane 18, and includes a rectangular frame member 24 joined to the anode 20 and the cathode 22. The frame member 24 includes two frame shaped sheets. Specifically, the frame member 24 includes a first frame shaped sheet 24a and a second frame shaped sheet 24b. The first frame shaped sheet 24a includes an inner peripheral portion 24an joined to an outer peripheral portion of the MEA 10a. The second frame shaped sheet 24b is joined to the first frame shaped sheet 24a.

The first frame shaped sheet 24a and the second frame shaped sheet 24b are directly joined together over the entire periphery (over the entire surface of the second frame shaped sheet 24b adjacent to the first frame shaped sheet 24a) by an adhesive layer 24c made of adhesive 24d. The first frame shaped sheet 24a and the second frame shaped sheet 24b are joined together by joining the second frame shaped sheet 24b to the outer peripheral portion of the first frame shaped sheet 24a. In the structure, an outer peripheral portion 24g of the frame member 24 is thicker than the inner peripheral portion of the frame member 24 (inner peripheral portion 24an of the first frame shaped sheet 24a).

The first frame shaped sheet 24a and the second frame shaped sheet 24b are made of resin material. Examples of materials of the first frame shaped sheet 24a and the second frame shaped sheet 24b include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

The inner peripheral portion 24an of the first frame shaped sheet 24a is disposed between an outer peripheral portion 20c of the anode 20 and an outer peripheral portion 22c of the cathode 22. Specifically, the inner peripheral portion 24an of the first frame shaped sheet 24a is interposed between the outer peripheral portion 18c of the electrolyte membrane 18 and the outer peripheral portion 20c of the anode 20. The inner peripheral portion 24an of the first frame shaped sheet 24a and the outer peripheral portion 18c of the electrolyte membrane 18 are joined together through the adhesive layer 24c.

The inner peripheral portion 24an of the first frame shaped sheet 24a includes an overlap part 24ak overlapped with the outer peripheral portion 20c of the anode 20 over the entire periphery as viewed in the thickness direction of the MEA 10a. The inner peripheral portion 24an of the first frame shaped sheet 24a may be interposed between the electrolyte membrane 18 and the cathode 22 in the state where the adhesive layer 24c is joined to the surface 18b of the electrolyte membrane 18.

A step is provided for the anode 20 at a position corresponding to an inner end 24ae of the first frame shaped sheet 24a. Specifically, the anode 20 has an inclined area 21c inclined from the electrolyte membrane 18, between an area 21a overlapped with the inner peripheral portion 24an of the first frame shaped sheet 24a and an area 21b overlapped with the electrolyte membrane 18.

The cathode 22 has a flat shape from an area 23a overlapped with the inner peripheral portion 24an of the first frame shaped sheet 24a to an area 23b overlapped with the electrolyte membrane 18. Instead of adopting the above structure, the cathode 22 may have an inclined area inclined from the electrolyte membrane 18 between the area 23a overlapped with the inner peripheral portion 24an of the first frame shaped sheet 24a and the area 23b overlapped with the electrolyte membrane 18 (area inclined in a direction opposite to the inclined area 21c).

Instead of adopting the above structure, the anode 20 may have a flat shape from the area 21a overlapped with the inner peripheral portion 24an of the first frame shaped sheet 24a to the area 21b overlapped with the electrolyte membrane 18, and the cathode 22 may have an inclined area inclined from the electrolyte membrane 18, between the area 23a overlapped with the inner peripheral portion 24an of the first frame shaped sheet 24a and the area 23b overlapped with the electrolyte membrane 18.

The second frame shaped sheet 24b is joined to the outer peripheral portion of the first frame shaped sheet 24a. The thickness T2 of the second frame shaped sheet 24b is larger than the thickness T1 of the first frame shaped sheet 24a. It should be noted that the thickness of the second frame shaped sheet 24b may be the same as the thickness of the first frame shaped sheet 24a. An inner end 24be of the second frame shaped sheet 24b is positioned outside the inner end 24ae of the first frame shaped sheet 24a (in a direction away from the MEA 10a) over the entire periphery. A gap G is formed between the inner end 24be of the second frame shaped sheet 24b and the outer end 22e of the cathode 22 over the entire periphery.

The inner end 24be of the second frame shaped sheet 24b is positioned inside the outer end 20e of the anode 20 over the entire periphery. The inner peripheral portion of the second frame shaped sheet 24b has an overlap part 24bk overlapped with the outer peripheral portion 20c of the anode 20 over the entire periphery as viewed in the thickness direction of the MEA 10a indicated by the arrow A. The inner end 24be of the second frame shaped sheet 24b is positioned outside the outer end 18e of the electrolyte membrane 18.

The adhesive layer 24c is provided over an entire surface 24as of the first frame shaped sheet 24a adjacent to the second frame shaped sheet 24b (cathode side). The adhesive layer 24c joins the inner peripheral portion 24an of the first frame shaped sheet 24a and the outer peripheral portion 18c of the electrolyte membrane 18. The first frame shaped sheet 24a is exposed to the gap G through the adhesive layer 24c, at a position of the gap G. As the adhesive 24d of the adhesive layer 24c, for example, liquid adhesive or a hot melt sheet is provided. The adhesive is not limited to liquid or solid adhesive, and not limited to thermoplastic or thermosetting adhesive, etc.

An overlap part K where the anode 20, the first frame shaped sheet 24a and the cathode 22 are overlapped together is held between a ridge 39 of the first separator 14 protruding toward the anode 20 and a ridge 37 of the second separator 16 protruding toward the cathode 22.

As shown in FIG. 1, at one end of the power generation cell 12 in the horizontal direction indicated by the arrow B, an oxygen-containing gas supply passage 30a, a coolant supply passage 32a, and a fuel gas discharge passage 34b are provided. The oxygen-containing gas supply passage 30a, the coolant supply passage 32a, and the fuel gas discharge passage 34b extend through the power generation cell 12 in the stacking direction indicated by the arrow A. The oxygen-containing gas is supplied through the oxygen-containing gas supply passage 30a, and the coolant is supplied through the coolant supply passage 32a. A fuel gas such as a hydrogen-containing gas is discharged through the fuel gas discharge passage 34b. The oxygen-containing gas supply passage 30a, the coolant supply passage 32a, and the fuel gas discharge passage 34b are arranged in the vertical direction indicated by the arrow C.

At another end of the power generation cell 12 in the direction indicated by the arrow B, a fuel gas supply passage 34a for supplying the fuel gas, a coolant discharge passage 32b for discharging the coolant, and an oxygen-containing gas discharge passage 30b for discharging the oxygen-containing gas are provided. The fuel gas supply passage 34a, the coolant discharge passage 32b, and the oxygen-containing gas discharge passage 30b extend through the power generation cell 12 in the direction indicated by the arrow A. The fuel gas supply passage 34a, the coolant discharge passage 32b, and the oxygen-containing gas discharge passage 30b are arranged in the direction indicated by the arrow C.

The first separator 14 has a fuel gas flow field 38 on its surface 14a facing the frame equipped MEA 10. The fuel gas flow field 38 is connected to the fuel gas supply passage 34a and the fuel gas discharge passage 34b. Specifically, the fuel gas flow field 38 is formed between the first separator 14 and the frame equipped MEA 10. The fuel gas flow field 38 includes straight flow grooves (or wavy flow grooves) extending in the direction indicated by the arrow B.

The second separator 16 has an oxygen-containing gas flow field 36 on its surface 16a facing the frame equipped MEA 10. The oxygen-containing gas flow field 36 is connected to the oxygen-containing gas supply passage 30a and the oxygen-containing gas discharge passage 30b. Specifically, the oxygen-containing gas flow field 36 is formed between the second separator 16 and the frame equipped MEA 10. The oxygen-containing gas flow field 36 includes a plurality of straight flow grooves (or wavy flow grooves) extending in the direction indicated by the arrow B.

A coolant flow field 40 is formed between a surface 14b of the first separator 14 and a surface 16b of the second separator 16. The coolant flow field 40 is connected to the coolant supply passage 32a and the coolant discharge passage 32b. The coolant flow field 40 extends in the direction indicated by the arrow B.

As shown in FIG. 2, a plurality of ridges 39 forming the fuel gas flow field 38 are provided on the surface 14a of the first separator 14 (surface facing the frame equipped MEA 10). The ridges 39 protrude toward the anode 20, and contact the anode 20. A plurality of ridges 37 forming the oxygen-containing gas flow field 36 are provided on the surface 16a of the second separator 16 (surface facing the frame equipped MEA 10). The ridges 37 protrude toward the cathode 22, and contact the cathode 22. The MEA 10a is held between the ridges 37, 39.

A plurality of bead seals 42 are provided on the surface 14a of the first separator 14 around the outer peripheral portion of the first separator 14, for preventing leakage of the fuel gas to the outside. The bead seals 42 are formed to expand toward the frame member 24 by press forming. The bead seal 42 on the inner side is formed around the fuel gas flow field 38, the fuel gas supply passage 34a, and the fuel gas discharge passage 34b, while allowing the fuel gas flow field 38 to be connected to the fuel gas supply passage 34a and the fuel gas discharge passage 34b. Though two bead seals 42 are provided in the embodiment, only one bead seal 42 may be provided.

A resin member 43 (or rubber member) is adhered to the front end surface of the ridge of each of the bead seals 42 by printing, coating, etc. The bead seals 42 contact the first frame shaped sheet 24a (an area overlapped with the second frame shaped sheet 24b) in an air tight or liquid tight manner through the resin member 43. The resin member 43 may be adhered to the first frame shaped sheet 24a.

Instead of the bead seals 42, elastic solid seals, for example, elastic rubber protruding toward the frame member 24 may be provided for the first separator 14.

Bead seals 44 are provided on the surface 16a of the second separator 16 around the outer peripheral portion of the second separator 16, for preventing leakage of the oxygen-containing gas. The bead seals 44 are formed to expand toward the frame member 24 by press forming. The bead seal 44 on the inner side is formed around the oxygen-containing gas flow field 36, the oxygen-containing gas supply passage 30a, and the oxygen-containing gas discharge passage 30b, while allowing the oxygen-containing gas flow field 36 to be connected to the oxygen-containing gas supply passage 30a and the oxygen-containing gas discharge passage 30b. Though two bead seals 44 are provided in the embodiment, only one bead seal 44 may be provided.

A resin member 45 (or rubber member) is adhered to the front end surface of the ridge of the bead seal 44 by printing, coating, etc. The bead seals 44 contact the second frame shaped sheet 24b (an area overlapped with the first frame shaped sheet 24a) in an air tight or liquid tight manner through the resin member 45. The resin member 45 may be adhered to the second frame shaped sheet 24b.

Instead of the bead seals 44, elastic solid seals, for example, elastic rubber protruding toward the frame member 24 may be provided for the second separator 16.

For example, polyester fiber, silicone, EPDM, FKM, etc. are used for the resin members 43, 45. The resin members 43, 45 are not essential, and may not be provided (In this case, the bead seals 42 directly contact the first frame shaped sheet 24a, and the bead seals 44 directly contact the second frame shaped sheet 24b.).

The bead seals 42 and the bead seals 44 face each other through the frame member 24. The outer peripheral portion of the frame member 24 (an area where the first frame shaped sheet 24a and the second frame shaped sheet 24b are overlapped with each other) is held between the bead seals 42 of the first separator 14 and the bead seals 44 of the second separator 16. In the case where the above solid seals are provided for the first separator 14 and the second separator 16, the outer peripheral portion of the frame member 24 (area where the first frame shaped sheet 24a and the second frame shaped sheet 24b are overlapped with each other) is held between the solid seal of the first separator 14 and the solid seal of the second separator 16.

Operation of the fuel cell stack 11a including the power generation cell 12 having the above structure will be described.

As shown in FIG. 1, an oxygen-containing gas is supplied to the oxygen-containing gas supply passage 30a, and a fuel gas such as a hydrogen gas is supplied to the fuel gas supply passage 34a. Further, a coolant such as pure water, ethylene glycol, or oil is supplied to the coolant supply passage 32a.

Therefore, the oxygen-containing gas flows from the oxygen-containing gas supply passage 30a to the oxygen-containing gas flow field 36 of the second separator 16, and moves in the direction indicated by the arrow B, and the oxygen-containing gas is supplied to the cathode 22 of the MEA 10a. In the meanwhile, the fuel gas flows from the fuel gas supply passage 34a to the fuel gas flow field 38 of the first separator 14. The fuel gas moves along the fuel gas flow field 38 in the direction indicated by the arrow B, and the fuel gas is supplied to the anode 20 of the MEA 10a.

Thus, in the MEA 10a, the oxygen-containing gas supplied to the cathode 22, and the fuel gas supplied to the anode 20 are partially consumed in the second electrode catalyst layer 22a and the first electrode catalyst layer 20a by electrochemical reactions to generate electrical energy.

Then, in FIG. 1, the oxygen-containing gas supplied to, and partially consumed at the cathode 22 is discharged along the oxygen-containing gas discharge passage 30b in the direction indicated by the arrow A. Likewise, the fuel gas supplied to, and partially consumed at the anode 20 is discharged along the fuel gas discharge passage 34b in the direction indicated by the arrow A.

Further, the coolant supplied to the coolant supply passage 32a flows into the coolant flow field 40 between the first separator 14 and the second separator 16, and then, the coolant flows in the direction indicated by the arrow B. After the coolant cools the MEA 10a, the coolant is discharged through the coolant discharge passage 32b.

Next, a method of producing the frame equipped MEA 10 according to the embodiment of the present invention will be described.

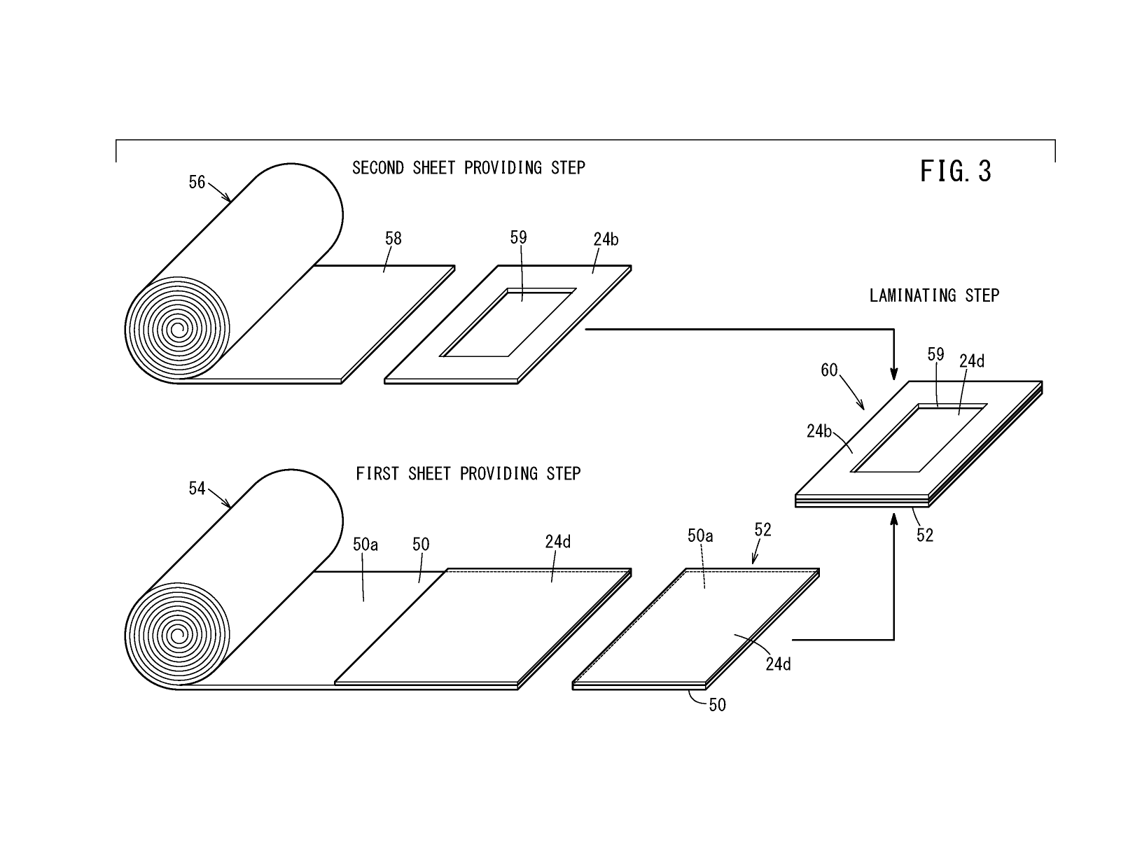

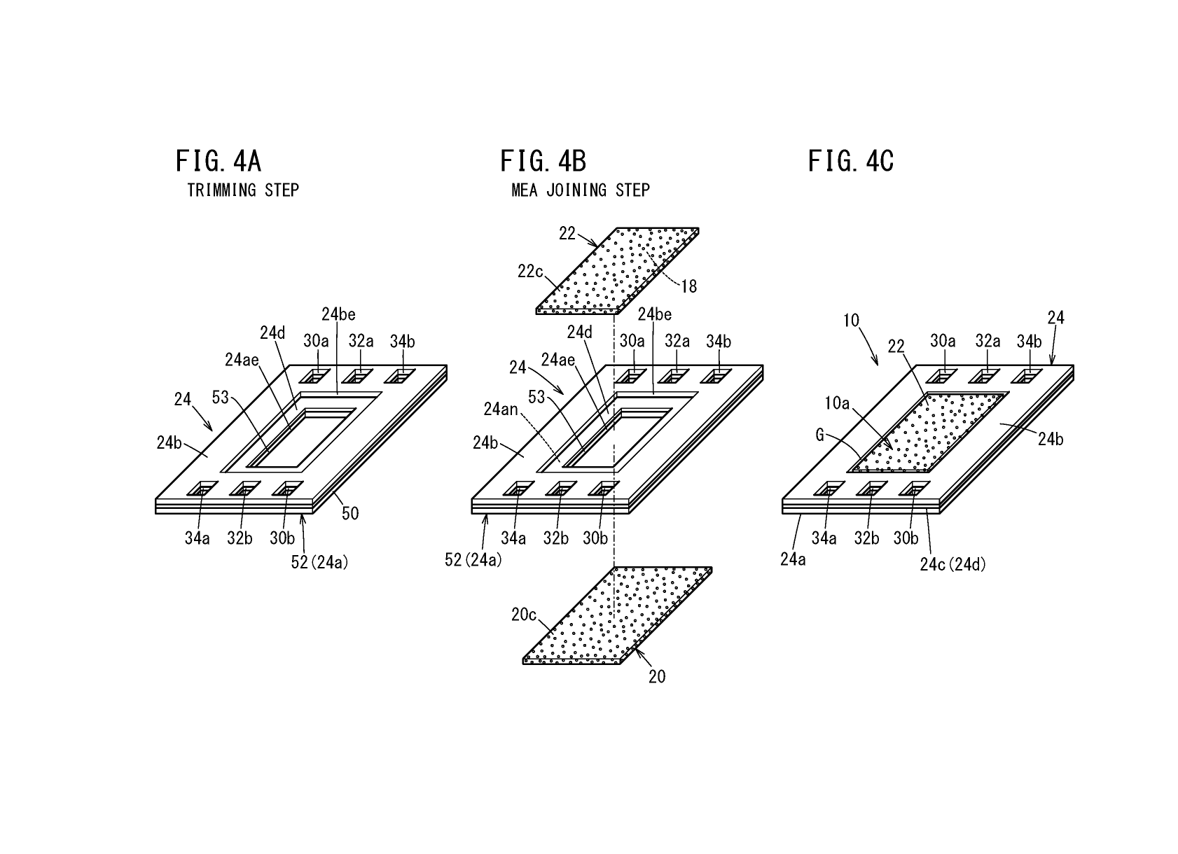

The method of producing the frame equipped MEA 10 includes a first sheet providing step, a second sheet providing step, and a laminating step (FIG. 3). Further, the method of producing the frame equipped MEA 10 includes a trimming step (FIG. 4A) and an MEA joining step (FIG. 4B).

As shown in FIG. 3 (lower left), in the first sheet providing step, an adhesive sheet 52 having adhesive 24d coated over one entire surface 50a of a first sheet 50 (first frame shaped sheet 24a before the first frame shaped sheet 24a is formed into the frame shape) is provided. Specifically, the first sheet 50 is unwound from a first roll 54, and the adhesive 24d is coated on the one surface 50a of the unwound first sheet 50 over the entire sheet width direction. Then, the first sheet 50 on which the adhesive 24d is coated is cut in the sheet width direction to obtain the rectangular adhesive sheet 52.

As shown in FIG. 3 (upper left), in the second sheet providing step, the second frame shaped sheet 24b is provided. Specifically, a second sheet 58 is unwound from a second roll 56 (second frame shaped sheet 24b before the second frame shaped sheet 24b is formed into the frame shape), and the unwound second sheet 58 is cut in the sheet width direction, and trimmed (primary trimming is performed) to form an opening 59 at the center of the second sheet 58. In this manner, the rectangular second frame shaped sheet 24b is obtained.

Then, as shown in FIG. 3 (right side), in the laminating step, the adhesive sheet 52 and the second frame shaped sheet 24b are joined together over the entire surface of the second frame shaped sheet 24b through the adhesive 24d. In this case, heat and a load are applied to the adhesive sheet 52 and the second frame shaped sheet 24b to join the adhesive sheet 52 and the second frame shaped sheet 24b by hot pressing. In a resulting intermediate member 60, the adhesive 24d is exposed through the opening 59 of the second frame shaped sheet 24b.

Next, as shown in FIG. 4A, in the trimming step, an opening 53 is formed at the center of the adhesive sheet 52, inside the inner end 24be of the second frame shaped sheet 24b (secondary trimming is performed). In this manner, the first sheet 50 is formed into the frame shape. Further, in this trimming step, the fuel gas supply passage 34a, the fuel gas discharge passage 34b, the oxygen-containing gas supply passage 30a, the oxygen-containing gas discharge passage 30b, the coolant supply passage 32a, and the coolant discharge passage 32b are formed.

Next, as shown in FIG. 4B, in the MEA joining step, the gap G (see FIG. 2) is provided between the inner end 24be of the second frame shaped sheet 24b and the outer end 22e of the cathode 22 (joined to the electrolyte membrane 18). In this state, the inner peripheral portion 24an of the first frame shaped sheet 24a is disposed between the outer peripheral portion 20c of the anode 20 and the outer peripheral portion 22c of the cathode 22 for joining these components. In this case, heat and a load are applied to the anode 20, the first frame shaped sheet 24a, and the electrolyte membrane 18, and the cathode 22 to join these components together by hot pressing. Thus, as shown in FIG. 4C, the frame member 24 is joined to the outer peripheral portion of the MEA 10a to form the frame equipped MEA 10.

The frame equipped MEA 10 and the power generation cell 12 according to the embodiment of the present invention offer the following advantages.

In the frame equipped MEA, the first frame shaped sheet 24a and the second frame shaped sheet 24b are joined together directly over the entire surface of the second frame shaped sheet 24b by the adhesive layer 24c. Improvement in the reliability for preventing formation of holes and/or cracks of the frame member 24 is achieved, and it is possible to realize the structure where deformation does not occur easily in the presence of the pressure difference between the anode and the cathode. That is, even in the case where holes and/or cracks are formed in the first layer (one of the first frame shaped sheet 24a and the second frame shaped sheet 24b) of the frame member 24, it is possible to maintain the desired gas shielding performance and the desired electrical insulating performance in the second layer (the other of the first frame shaped sheet 24a and the second frame shaped sheet 24b). Further, by the adhesive layer 24c provided over the entire surface between the first frame shaped sheet 24a and the second frame shaped sheet 24b, it is possible to prevent cracks formed in one of the sheets from being spread to the other of the sheets. Moreover, since the electrolyte membrane 18 is not provided between the first frame shaped sheet 24a and the second frame shaped sheet 24b, it is possible to achieve reduction in the production cost.

The adhesive layer 24c is provided on the entire surface 24as of the first frame shaped sheet 24a adjacent to the second frame shaped sheet 24b. The adhesive layer 24c joins the inner peripheral portion 24an of the first frame shaped sheet 24a and the outer peripheral portion 18c of the electrolyte membrane 18. In the structure, it is possible to coat the adhesive layer 24c over the one entire surface of the first frame shaped sheet 24a for adhering the first frame shaped sheet 24a and the second frame shaped sheet 24b together, and adhering the first frame shaped sheet 24a and the electrolyte membrane 18 together. Accordingly, reduction in the production cost is achieved.

The bead seals 42 are formed integrally with each of the first separator 14 and the second separator 16. The bead seals 42 protrude toward the frame members 24 for preventing leakage of the reactant gas. The bead seals 42 of the first separator 14 and the bead seals 44 of the second separator 16 hold the frame member 24 in the thickness direction from both sides. In the structure, the outer peripheral portion of the relatively thick frame member 24 is held between the bead seals 42, 44. Therefore, it is possible to obtain suitable seal surface pressure, and reliably achieve suitable sealing performance. Further, since the inner peripheral portion of the relatively thin frame member 24 is positioned between the anode 20 and the cathode 22, it is possible to effectively suppress the thickness of the joint portion between the frame member 24 and the MEA 10a.

The present invention is not limited to the above embodiments. Various modifications can be made without departing from the gist of the present invention.

What is claimed is:

1. A frame equipped membrane electrode assembly comprising:
a membrane electrode assembly including an electrolyte membrane, a first electrode provided on one surface of the electrolyte membrane, and a second electrode provided on another surface of the electrolyte membrane, a surface size of the second electrode being smaller than a surface size of the first electrode; and
a frame member provided over an entire periphery of an outer peripheral portion of the membrane electrode assembly,
wherein the frame member includes a first frame shaped sheet and a second frame shaped sheet, an inner peripheral portion of the first frame shaped sheet is joined to the outer peripheral portion of the membrane electrode assembly, and the first frame shaped sheet and the second frame shaped sheet are joined together in a thickness direction;
the inner peripheral portion of the first frame shaped sheet is disposed between an outer peripheral portion of the first electrode and an outer peripheral portion of the second electrode;
a gap is formed between an inner end of the second frame shaped sheet and an outer end of the second electrode; and
the first frame shaped sheet and the second frame shaped sheet are joined together directly over an entire periphery by an adhesive layer.

2. The frame equipped membrane electrode assembly according to claim 1, wherein the inner peripheral portion of the first frame shaped sheet includes an overlap part overlapped with the outer peripheral portion of the first electrode as viewed in a thickness direction of the membrane electrode assembly.

3. The frame equipped membrane electrode assembly according to claim 1, wherein the adhesive layer is provided over an entire surface of the first frame shaped sheet adjacent to the second frame shaped sheet; and
the inner peripheral portion of the first frame shaped sheet and an outer peripheral portion of the electrolyte membrane are joined together by the adhesive layer.

4. The frame equipped membrane electrode assembly according to claim 1, wherein an inner peripheral portion of the second frame shaped sheet includes an overlap part overlapped with the outer peripheral portion of the first electrode as viewed in a thickness direction of the membrane electrode assembly.

5. The frame equipped membrane electrode assembly according to claim 1, wherein an entire surface of the second frame shaped sheet adjacent to the first frame shaped sheet is joined to the first frame shaped sheet directly over the entire periphery by the adhesive layer.

6. The frame equipped membrane electrode assembly according to claim 1, wherein a thickness of the first frame shaped sheet and a thickness of the second frame shaped sheet are same.

7. The frame equipped membrane electrode assembly according to claim 1, wherein a thickness of the second frame shaped sheet is larger than a thickness of the first frame shaped sheet.

8. A fuel cell comprising:
a frame equipped membrane electrode assembly; and
separators stacked on both sides of the frame equipped membrane electrode assembly, respectively,
the frame equipped membrane electrode assembly comprising:
a membrane electrode assembly including an electrolyte membrane, a first electrode provided on one surface of the electrolyte membrane, and a second electrode provided on another surface of the electrolyte membrane, a surface size of the second electrode being smaller than a surface size of the first electrode; and
a frame member provided over an entire periphery of an outer peripheral portion of the membrane electrode assembly,
wherein the frame member includes a first frame shaped sheet and a second frame shaped sheet, an inner peripheral portion of the first frame shaped sheet is joined to the outer peripheral portion of the membrane electrode assembly, and the first frame shaped sheet and the second frame shaped sheet are joined together in a thickness direction;
the inner peripheral portion of the first frame shaped sheet is disposed between an outer peripheral portion of the first electrode and an outer peripheral portion of the second electrode;
a gap is formed between an inner end of the second frame shaped sheet and an outer end of the second electrode; and
the first frame shaped sheet and the second frame shaped sheet are joined together directly over an entire periphery by an adhesive layer.

9. The fuel cell according to claim 8, wherein the overlap part where the first electrode, the first frame shaped sheet, and the second electrode are overlapped together is held between a ridge provided in one of the separators and protruding toward the first electrode and a ridge provided in another of the separators and protruding toward the second electrode.

10. The fuel cell according to claim 8, wherein a bead seal is formed integrally with each of the separators to protrude toward the frame member, and configured to prevent leakage of a reactant gas; and
an overlap area of the frame member where the first frame shaped sheet and the second frame shaped sheet are overlapped together is held between the bead seal of one of the separators and the bead seal of the other of the separators from both sides in a thickness direction.

11. The fuel cell according to claim 8, wherein a solid seal made of an elastic member is provided for each of the separators, and configured to prevent leakage of a reactant gas; and
an overlap area of the frame member where the first frame shaped sheet and the second frame shaped sheet are overlapped together is held between the solid seal of one of the separators and the solid seal of another of the separators from both sides in a thickness direction.

12. The fuel cell according to claim 8, wherein the first electrode is an anode; and
the second electrode is a cathode.

13. The fuel cell according to claim 8, wherein the first electrode is a cathode; and
the second electrode is an anode.

14. The fuel cell according to claim 8, wherein a thickness of the first frame shaped sheet and a thickness of the second frame shaped sheet are same.

15. The fuel cell according to claim 8, wherein a thickness of the second frame shaped sheet is larger than a thickness of the first frame shaped sheet.

16. A method of producing a frame equipped membrane electrode assembly, the frame equipped membrane electrode assembly comprising:
a membrane electrode assembly including an electrolyte membrane, a first electrode provided on one surface of the electrolyte membrane, and a second electrode provided on another surface of the electrolyte membrane, a surface size of the second electrode being smaller than a surface size of the first electrode; and
a frame member provided over an entire periphery of an outer peripheral portion of the membrane electrode assembly,
wherein the frame member includes a first frame shaped sheet and a second frame shaped sheet, an inner peripheral portion of the first frame shaped sheet is joined to the outer peripheral portion of the membrane electrode assembly; and
the first frame shaped sheet and the second frame shaped sheet are joined together in a thickness direction,
the method comprising the steps of:
providing a first sheet by providing an adhesive sheet having adhesive coated on one entire surface of the first sheet as the first frame shaped sheet before being formed into a frame shape;
providing a second sheet by providing the second frame shaped sheet as the second sheet; and
laminating the adhesive sheet and the second frame shaped sheet by joining the adhesive sheet and the second frame shaped sheet over an entire periphery of the second frame shaped sheet through the adhesive.

17. The method of producing the frame equipped membrane electrode assembly according to claim 16, further comprising the steps of:
trimming the first sheet in a frame shape by forming an opening in the adhesive sheet at a position inside an inner end of the second frame shaped sheet; and
joining components of an MEA in a state where a gap is formed between an inner end of the second frame shaped sheet and an outer end of the second electrode, by disposing the inner peripheral portion of the first sheet between the outer peripheral portion of the first electrode and the outer peripheral portion of the second electrode, and joining the membrane electrode assembly and the frame member together.

18. The method of producing the frame equipped membrane electrode assembly according to claim 16, wherein a thickness of the first frame shaped sheet and a thickness of the second frame shaped sheet are same.

19. The method of producing the frame equipped membrane electrode assembly according to claim 16, wherein a thickness of the second frame shaped sheet is larger than a thickness of the first frame shaped sheet.
